(19) United States
(12) Patent Application Publication
(10) Pub. No.: US 2004/0122936 A1
(43) Pub. Date: Jun. 24, 2004

(54) Methods and apparatus for collecting, managing and presenting enterprise performance information

(75) Inventors: Karla D. Mizelle, Raleigh, NC (US); Richard J. Popillo, Raleigh, NC (US); Cheryl Crane, Raleigh, NC (US); Mark Dabkowski, Newtown Square, PA (US); Kirsten Ioos, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE MORTGAGE HOLDINGS, LLC, Raleigh, NC

(21) Appl. No.: 10/248,158

(22) Filed: Dec. 20, 2002

(51) Int. Cl. G06F 15/173

(52) U.S. Cl. 709/224; 709/225

(57) ABSTRACT

Techniques and systems for managing information providing insight into the operation of an enterprise are described. A system employs a plurality of servers and workstations to carry out the operations of the enterprise and stores data elements generated during those operations. A data management application allows an administrator to create and store metric records identifying selected data elements and information, to compute values for data elements and information belonging to the metric records and defining the presentation of the data elements and information. Values of metric records are periodically updated based on processing of data elements identified in the metric records. A reviewer is able to select desired metric records for examination and information contained in the metric records is presented to the reviewer in an initial format defined in the metric records.

### BACKGROUND OF INVENTION

The present invention relates generally to improved techniques for collecting and presenting data relating to the performance of an enterprise. More particularly, the invention relates to advantageous systems and techniques for defining metrics comprising information extracted from data items relating to the performance of the enterprise and for the automated collection, organization and presentation of information relating to specified metrics.

The activities of an enterprise, such as a business, typically produce results that can be can be examined or compared with predetermined criteria to determine whether and how well the enterprise is meeting its goals. The results to be evaluated can be expressed in numerical terms or otherwise classified or categorized. For example, the revenue, cost of goods, administrative costs and profitability can be expressed as numbers and these numbers, or trends in the numbers, can be compared against goals or expectations, or otherwise evaluated. Customer satisfaction or familiarity with a product or service can be evaluated through surveys or other vehicles and the level of customer satisfaction or familiarity can be expressed as a number, such as 80 percent satisfaction, complaints per 1000 transactions, or as a classification level, such as low, average, high or the like. In order to understand the activities of the enterprise and to determine whether it is performing well and achieving its goals, it is important to collect data relating to its activities and performance and to process and present this information so that it can be understood.

Many enterprises are very large, comprising numerous units or divisions, each of which performs numerous activities and whose operations produce many results or events which may suitably be evaluated. Evaluation of such results or events can provide insight into the performance of the unit or division, and into the enterprise as a whole. Many systems for collecting and evaluating business information are relatively cumbersome, and involve collecting data relating to a number of activities and compiling this data into metrics to be used to show the performance of the unit, division or enterprise carrying out the activity. The presentation and evaluation of the data is a part of the process of collecting the data. The data is collected and presented in predefined graphs, charts or other formats. The data is frequently presented in database or spreadsheet form. If the party reviewing the data is unfamiliar with the routines used to present the data, he or she may have little opportunity to modify the presentation of the data or to specify the data to be presented.

There exists, therefore, a need for systems and techniques allowing simple ways to specify data to be collected and evaluated in order to serve as metrics to the performance of an enterprise, to specify criteria against which the data is to be evaluated, and to specify the data to be reviewed and the presentation of the data, with the selection of the data to be presented and the format of the presentation being changeable in a simple way by the party reviewing the data.

### SUMMARY OF INVENTION

A system according to an aspect of the present invention comprises a plurality of servers and workstations for carrying out activities in the operation of the enterprise, an operations server for storing data elements generated during the activities of the enterprise in an operations database and an analysis server for collecting, processing and presenting the data elements so as to provide insights into the performance of the enterprise.

A data management application hosted on the analysis server comprises an administrator module for allowing an administrator to enter selections for assembling a metric record. The administrator module is operative to store each metric record in a metric database upon completion. The data management application also comprises a data analysis module for examining each metric record in the metric database and searching the operations database. The data analysis module is operative to process data elements identified in the metric database in order to generate values for metric records and to update the metric records with the generated values. The system further comprises a presentation module for searching the metric database in response to inputs from a reviewer requesting information from metric records and presenting the desired information in response to the reviewer inputs.

A method of management and evaluation of data generated during the conduct of an enterprise according to a further aspect of the present invention includes presenting an administrator with an interface allowing definition of metric records. The definitions are to be used to format and present information providing insight into the activities of the enterprise. Each metric record identifies data elements generated in carrying out the activities of the enterprise and stored in an operations database. Upon each entry by the administrator of data defining a metric record, the metric record is stored in a metric database. The metric database is examined for metric records. For each metric record, the operations database is searched for data elements identified in the metric record. The data elements are processed to compute values for the metric records and the metric records are updated with the values.

When a reviewer wishes to review information, an interface is presented allowing the reviewer to direct presentation of information contained in selected metric records. The selected metric records are presented as directed by the reviewer.

A more complete understanding of the invention, as well as further features and advantages of the invention, will be apparent from the following Detailed Description and the accompanying drawings.

### BRIEF DESCRIPTION OF DRAWINGS

FIG. 1 illustrates a data management system according to an aspect of the present invention;

FIG. 2 illustrates details of an administrator module according to an aspect of the present invention;

FIGS. 3-16 illustrate displays providing user interfaces to an administrator module according to an aspect of the present invention.

FIG. 17 illustrates details of a data management module according to an aspect of the present invention;

FIG. 18 illustrates details of a presentation module according to an aspect of the present invention;

FIGS. 19-23 illustrate an exemplary series of displays generated by a presentation module according to an aspect of the present invention;

FIGS. 24 and 25 illustrate an additional exemplary series of displays generated by a presentation module according to an aspect of the present invention, and

FIG. 26 illustrates the steps of a process of data compilation, analysis and presentation according to an aspect of the present invention.

### DETAILED DESCRIPTION

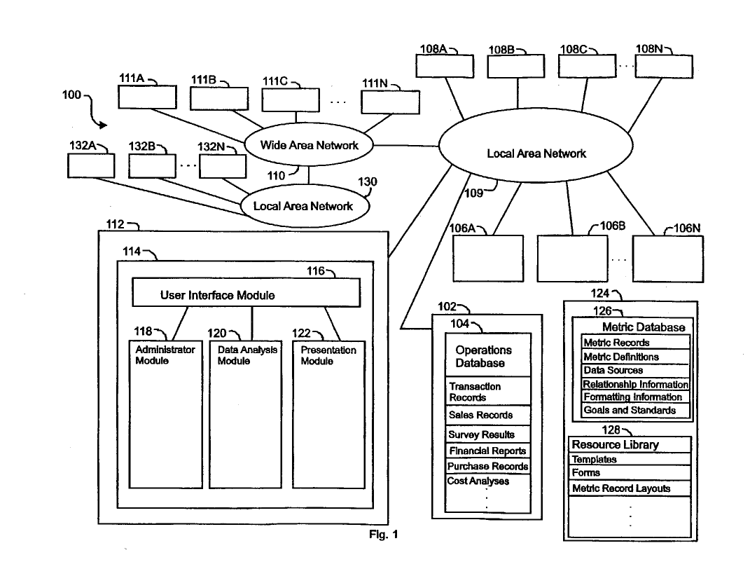

FIG. 1 illustrates a business management system 100 according to an aspect of the present invention. The system 100 includes a storage server 102, hosting an operations database 104. The database 104 stores data generated in the course of the enterprise and which can be examined and processed in order to gain insight into the conduct of the enterprise. Data may suitably include transaction records, sales records, survey results, for example the results of surveys taken to determine customer or employee satisfaction, financial reports, purchase records, cost analyses, and any of numerous other types of data that may suitably be compiled in conducting an enterprise. The system 100 preferably includes a plurality of operating servers 106A . . . 106N, used to provide services and carry out operations in the performance of the enterprise. The system 100 also comprises a plurality of workstations 108A . . . 108N, communicating with the operating servers 106A . . . 106N and with the storage server 102. Communication is suitably conducted through a local area network 109. One or more of the workstations 108A . . . 108N may suitably be employed by users to provide an interface with the storage server 102 and the operating servers 106A . . . 106N in order to carry out transactions or to perform operations. It will be recognized that while a single storage server 102 is presented here, and is presented as distinct from the operating servers 106A . . . 106N, the activities carried out using the system 100 may be assigned to the servers 102 and 106A . . . 106N as desired for the efficient operation of the system 100. In addition, the system 100 may further comprise a wide area network 110, connected to the local area network 109. The wide area network 110 may suitably be a publicly accessible network such as the Internet, and the various components of the system 100 using the wide area network 110 for communication may suitably employ commonly used security protocols such as encryption and digital signature in order to provide authentication and privacy for communications. The wide area network 110 may be used to provide access to the servers 102 and 106A . . . 106N by remotely located terminals similar to the terminals 108A . . . 108N and may also provide connections to additional resources usable by the components connected to the network 109. In addition, the wide area network 110 may suitably be accessible by customer operated terminals, for example the terminals 111A . . . 111N.

As users employ the workstations 108A . . . 108N to carry out activities, data related to those activities is stored in the database 104. Suitably, whenever a transaction is carried out, relevant data related to that transaction is stored in the database 104. For example, the sale of a product may create a record of the sale date, the sale price, an identification of the product sold and an adjustment to inventory records in order to show a reduction of the inventory on hand, with the record being stored in the database 104. The purchase of a supply of products may create a record of purchase date, identification and cost of products and a record of an increase in inventory, with that record being stored in the database 104. Execution of a transaction involving an intangible product, such as the issuance of a policy of mortgage insurance, may create a record of the policy premium, the amount of the policy, the effective date of the policy, an estimate of the risk of default on the transaction covered by the policy and other relevant data. Maintenance of such a policy may include updates to the mortgage balance remaining, updated value of the real estate securing the mortgage covered by the policy, and whether or not the policy has become delinquent. Other activities of the enterprise, such as hiring of employees, rental of office space and payment of utilities may be carried out or monitored using the system 100.

In addition, the customer terminals 111A . . . 111N may suitably be employed by customers to carry out transactions using the system 100. Customers may, for example, be able to place orders, check the status of orders, submit credit applications or perform other transactions that can be managed automatically. Data related to transactions carried out by customers may suitably be stored in the database 104, providing a source of data obtained by submissions from customers and requiring little or no intervention from employees of the enterprise operating the system 100.

Suitably, all data stored in the database 104 is generated by the carrying out of transactions or monitoring of data as part of the normal operation of the enterprise. The database 104 thus represents a pool of data from which elements can be extracted and processed in order to gain insight into the enterprise.

The data stored in the database 104 can be extracted, processed and classified in order to gain insight into the performance of the activities or transactions generating the data, and thus to the enterprise as a whole. To this end, the system 100 is employed to define a set of metrics and to format and present the set of metrics. Each metric is generated by identifying and processing relevant data items. The metrics are suitably grouped into related categories, chosen to provide insight into data and activities falling within the categories. The arrangement of the categories may suitably include hierarchical arrangements. For example, one metric may suitably be revenue. A hierarchical category of metrics related to revenue may exist, for example revenue related from sales of a particular product, for example a particular brand of cereal, revenue from sales of a closely grouped category of products, for example cereals marketed to children, revenue from sales of a broader category of products, for example cereals in general, and on through whatever succession of categories is desired, suitably finishing with total revenue of the enterprise as a whole. Each of the metrics in this hierarchical category may suitably be associated with other related metrics, for example costs of the goods, administrative costs in selling the goods, marketing expenses attributable to the goods, net profits attributable to sales of the goods, and so on.

In order to provide an automated system for designing metrics, gathering data in order to assign values to the metrics and formatting and presenting the metrics in meaningful ways, the system 100 includes an analysis server 112 hosting a data management application 114. The data management application 114 includes a user interface module 116, an administrator module 118, a data analysis module 120 and a presentation module 122. The user interface module 116 allows a user to invoke the administrator module 118 or the presentation module 122 and to enter parameters for the initial state of the module invoked. The data management application 114 stores and manages information that may suitably be stored on a data analysis storage server 124, which maintains a metric database 126 and a resource library 128. The metric database 126 receives and stores metric records created and processed by the data management application 114, and the resource library 128 stores templates, forms and other information used by the data management application 114 to format user inputs and process data.

The administrator module 118 allows an administrator to create and modify metrics, to create categories and groupings of metrics and to establish links between metrics. The administrator module 118 also allows a user to define how the metrics will be presented to a reviewer, for example in lists, charts or graphs. The administrator module 118 may also allow the administrator to specify ways in which the reviewer will be able to change the presentation, for example by allowing the reviewer to enter time periods in order to plot a metric over a desired time frame. The administrator module 118 also allows the administrator to establish goals and standards for comparison for the various metrics, in order to show the reviewer whether a metric indicates good or poor performance. The administrator module 118 presents an administrator preparing a metric record with a simplified user interface, suitably comprising a form or series of forms. The administrator can select entries from lists or menus and can enter data in fields in order to specify data elements belonging to metric records, and can make selections from a standardized set of choices or adjust parameters within a standardized framework in order to define how metrics are to be presented.

The data analysis module 120 preferably runs at all times the system 100 is operating, examining the database 104 to identify and process data elements relating to metrics created by the administrator module 118. For each metric, the data analysis module 120 searches the database 114 for data elements related to the metric and performs operations on the data elements to determine the value of the metric. For example, in order to find the value of a metric of total revenue for a category of sales, the data analysis module 120 may search through the database 114 to records of sales in the category and may sum the revenue from each sale to find the total revenue for the category. The data analysis module 120 may then compare the value of the metric against a goal and set a flag indicating whether or not the value of the metric meets the goal.

The presentation module 122 may suitably be executed when invoked by the user interface module 116, or, depending on the design of the data management application 114, may be able to be invoked independently without a need to be invoked by the user interface module 116. The presentation module 122 presents selected metrics to a reviewer in a specified format that allows the reviewer convenient access to related items. The presentation module 122 preferably accompanies the display of the metric with status indicators, such as color coding of metric descriptions and details or accompaniment of the metric by color coded icons, to show whether or not the value of a metric is in a desired range. For example, if revenue is unacceptably low, the name of the metric may be displayed in red, or the value of the metric may be accompanied by a red colored icon.

The data management application 114 may suitably be invoked by a user employing one of the workstations 108A . . . 108N of FIG. 1, suitably by pointing a hypertext browser to a uniform resource locator (URL). Pointing of the browser to the URL will typically be accomplished by activating a hypertext link present on a hypertext page employed by the user. For example, the system 100 may present an introductory page to the user whenever the user logs into the network 109. The introductory page may offer a number of options presented as hypertext links. The hypertext links may include a link to the data management application 114. Additionally, any page employed by a user in performing operations may, if desired, be designed so as include a hypertext link to the data management application 114. In addition, in order to allow the user freedom to invoke the data management application whenever desired, pointing of the browser to the URL may be accomplished by typing the URL into a suitable field in the browser. In order to provide for universality of use, each of the components of the data management application 114 preferably employs an arrangement of hypertext pages as a user interface, allowing a user to invoke and work with the desired component using widely available hypertext browsers. Such an implementation simplifies access from remote locations through the wide area network 110, and provides a standardized way for a user to provide commands and information to and receive information from the data management application 114.

When the data management application 114 is invoked, the user interface module 116 is activated and identifies the user, suitably by examining the user's network identification or alternatively by requesting and receiving a username and password created for use with the data management application 114. Upon identifying the user, the user interface module 116 suitably identifies a privilege level of the user and prepares a parameter to be supplied to the administrator module 118 or the presentation module 122, in order to define the activities the user may conduct. For example, a user may have administrator privileges with respect to some metric records and be allowed to invoke the administrator module 118 in order to make changes to those metric records. The same user may only have reviewer privileges with other metric records and allowed to use the presentation module 122 to review metric information included in those metric records.

Once the privilege level of the user has been identified, the user interface module 116 then prepares an introductory display allowing the user to select the administrator module 118 or the presentation module 122. Preferably, the administrator module 118 and the presentation module 122 are designed so that either can be invoked independently without a need to first invoke the user interface module 116. The administrator module 118 can also suitably be invoked from the presentation module 122 and the presentation module 122 can suitably be invoked from the administrator module 118, allowing a user to alternate easily between designing and modifying a metric and examining displays of the metric.

When the user invokes the administrator module 118, the administrator module 118 presents an initial administrator menu allowing a user to select one of a number of activities relating to designing metrics and specifying a format for the presentation of metrics. The options presented in the menu suitably include creation or modification of a metric, specification of presentation formats and specification of criteria against which metrics are to be compared, as well as specification of alerts to be issued when metrics deviate from the criteria and the degree of deviation that will trigger an alert. Additional options include choosing to invoke a template for batch loading of data and choosing to display instructions for batch loading of data. Templates may suitably be retrieved from the resource library 128 for presentation to the user.

As each metric is created, a metric record is created for the metric and stored in the metric database 126. The metric record includes the characteristics and properties of the metric, as well as the goals and standards set for the metric and the formatting and display options chosen for the metric. Additional details of the various operations performed by the administrator module 118, including details of the design and display formatting of metrics, are described in greater detail below.

The data analysis module 120 searches the metric database 126 for records of metrics and uses information contained in each record of a metric to search the operating database 104 for data relating to that metric. Depending on the design of the system 100, the data analysis module 120 may run continuously during the operation of the system 100, may operate whenever a change is made to a metric using the administrator module 118 or may be invoked when a metric is to be presented using the presentation module 122. The data analysis module 120 searches for operating database records identified as a source of data for each metric and processes the data in the records to determine a value or set of values associated with the metric. The value is then stored in the metric database 126 as part of the metric record. The data analysis module 120 also analyzes each record within the metric database 126 to compare the value of the metric against predetermined goals and standards, and to set flags and status indicators based on comparisons of the value of the metric against the goals and standards.

The presentation module 122 may be invoked through the user interface module 116, or may suitably be invoked from a display tailored to a user, such as a page displaying a user's job functions and responsibilities. In either event, the user's identification and privileges may suitably be examined and the presentation module 122 provided with parameters based on user records associated with the user identification. The parameters will define the metrics that the user is responsible for maintaining or is most likely to wish to review, so that the user may be presented with an initial display showing the metrics or categories of interest. The initial display will also preferably provide the user with ways to select any desired metric for which the user has authorization, for example by allowing the user to enter a metric or category name or to search or browse through a list.

Once the user has selected the metric desired, the presentation module displays the metric using the format defined by the record in the metric database. Related metrics may suitably be displayed simultaneously or in parallel, for example as tables or charts displayed at the same time or as graphs simultaneously displayed on the same axes. Each metric is preferably accompanied by status alerts indicating whether or not the metric meets established goals. The metric information is preferably displayed in such a way that the user can easily retrieve related data. For example, the name of a metric may be displayed as a hypertext link, so that activating the link will retrieve the names of related metrics that can be selected for display. To take another example, a status alert can be displayed as a hypertext icon, so that activating the icon displays details about the goals that have been set for the metric and how the value of the metric compares to the goals.

The various resources of the system 100 may suitably be made accessible to any user having satisfactory security authorization and following prescribed security protocols. Thus, the local area network 109, providing the data management and storage resources described above, may be made accessible to authorized users of a remote local area network 130, connecting to the wide area network 110 and providing access to the remote terminals 132A . . . 132N. Users of the terminals 132A . . . 132N may suitably be provided with the same access as users of the terminals 108A . . . 108N, communicating with the various servers such as the analysis server 112 through the wide area network 110 and the local area network 109. Users of the terminals 132A . . . 132N may act as reviewers or administrators for various metrics, depending on their security authorizations, in the same way as do users of the terminals 108A . . . 108N. Moreover, additional resources similar to those describe here may be distributed or duplicated over a large geographic area, with the wide area network 110 providing any authorized user with a connection to a desired resource. Thus, an intranet can be established by a large organization having many offices, in order to perform data management as described herein, with various resources belonging to the intranet being identified through security authorizations and protocols and communicating with one another through the wide area network 110. In this way, users at a corporate office, for example, may review metrics created and stored by administrators at operational centers remote from the corporate office, and users at operational centers may review metrics created and stored by administrators at the corporate office. The physical location at which data is generated or at which a metric record is designed can be irrelevant to the operation of the system 100.

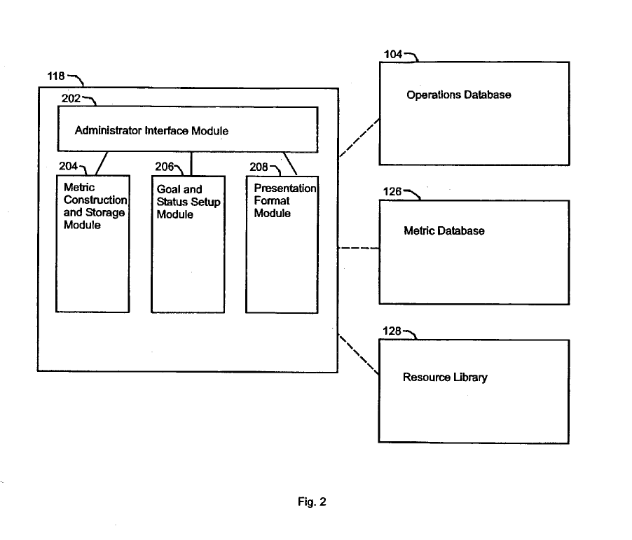

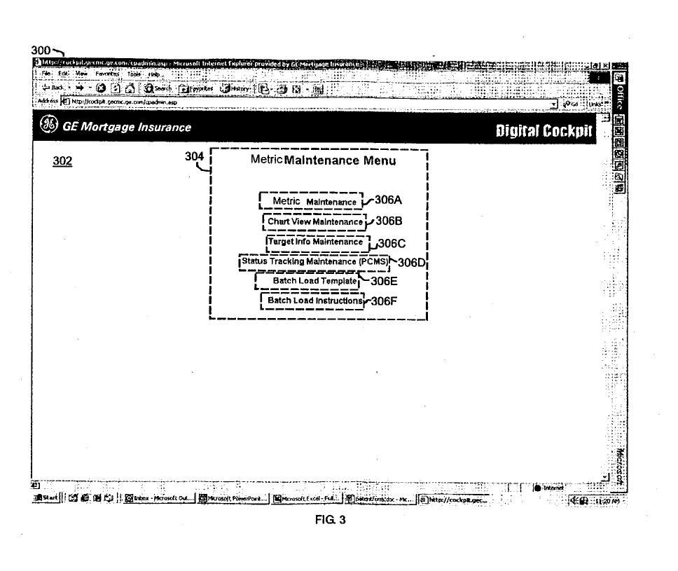

FIG. 2 illustrates additional details of the administrator module 118, showing its interaction with the operations database 104, the metric database 126 and the resource library 128. The administrator module 118 includes an administrator interface module 202, a metric construction and storage module 204, a goal and status setup module 206 and a presentation format module 208. When the administrator module 118 is invoked, the administrator interface module 202 suitably receives and stores identifying information about the user, in order to adapt the choices and selections to the user. The administrator interface display initially presents an initial menu by retrieving and displaying an appropriate interface form based on a menu selection by an administrator. The menu and the interface forms are preferably in the form of hypertext pages, to allow entry of information in a standardized and widely available format.

The interface form suitably allows a choice between various operations, such as modifying a metric, modifying formats in which information is to be presented or modifying goals and criteria against which metrics are to be compared. When an administrator chooses an operation, a new interface is preferably retrieved from the resource library 128 and displayed for the administrator. Preferably, the display of a new interface is accomplished by the opening of a hypertext browser window and the presentation in that window of an initial hypertext page presenting choices to the administrator. The administrator is presented with a selection of menus and choices to be used in conducting the desired operation, such as constructing or modifying a metric. The initial hypertext page preferably includes navigational elements allowing the administrator to enter information and call up the next page in a sequence. Typically, a number of linked pages will be employed to allow information entry by the administrator, with the administrator module updating the metric database 126 at suitable intervals, for example when the administrator completes a page and navigates to the next page in a set.

If the administrator has chosen to modify a metric, the administrator is presented with a display presenting choices to be made in modifying the metric. Choices may suitably include the business unit to which the metric relates and the specific operation to be performed. Operations include creating or adding a metric, modifying an existing metric, deleting a metric or other choices. Adding and modifying a metric are similar, allowing the administrator' to specify parameters for the metric. However, if an administrator has chosen to add a metric, the form for creating the metric will not contain any selections or entries other than default selections or entries. On the other hand, if the administrator has chosen to modify an existing metric, the existing parameters of the metric will be displayed and can be replaced by the administrator or left as they are. In either case, the administrator is presented with a selection of displays, suitably hypertext pages, with buttons and fields allowing the administrator to enter desired values in order to set parameters. Typical elements of a metric are a metric name, groups to which a metric belongs, the position of the metric in hierarchical group the relationship of the metric to other metrics in the same group or hierarchy, and specifications as to how the value of the metric is to be determined. For example, an administrator may specify subordinate metrics or other data elements to be used to be used to compute the value of the metric, and the operations to be performed on the data elements. For example, formulas may be specified to which the data elements are to be used as inputs, comparisons between data elements may be specified, with the value of the metric to be based on the comparison, or other operations may be specified to yield the value for the metric.

For example, an administrator may wish to establish a metric showing revenue from sales of cereal. Records reflecting sales of cereal reside in the operations database 104, with each record including a group identifier field showing that it represents sales of cereal, and having a field showing the sale amount. The administrator module 118 allows the administrator to enter the group identifier and sale amount field for the records as the source of the data for the metric. When the value of the metric is to be computed, the data processing module 120 will search the operations database 104 for records showing the designated group identifier, and will take value information from the sales amount fields of those records to compute the value of the revenue metric.

The values of metrics in a hierarchical grouping typically influence the metrics at a higher level in the hierarchy and are influenced by the metrics at a lower level in the hierarchy. For example, a hierarchy of metrics may include total revenue, revenue from sales of cereal, revenue from cereals made by a particular manufacturer and revenue from cereals of a particular brand from that manufacturer. The revenue from cereals of a particular brand influences the revenue from cereals of a manufacturer, which in turn influences the revenue from cereals in general, which in turn influences total revenue. The metric construction and storage module 204 allows the administrator to construct links between metrics records, so that values computed for metrics will properly influence or be influenced by related metrics. The degree to which a metric influences or is influenced by metrics at other levels in a hierarchy varies. Therefore, the metric construction and storage module 204 allows the administrator to include weightings in a metric record, specifying the degree of influence the metric has on other related metrics.

An administrator can create metric records without a need to be skilled in the use of data processing tools such as spreadsheets or databases. Instead, the metric construction and storage module 204 presents the administrator with a framework for construction of a metric record and processes the administrator's inputs and choices in order to create the metric record. The metric construction and storage module 204 allows the administrator to specify names and paths of data elements making up the metric record. The administrator is preferably familiar with the data elements making up the metric records being designed. These data elements preferably follow naming conventions used throughout the system 100 and used in operations generating data stored in the operations database 104. The metric construction and storage module 204 may suitably provide forms presenting fields in which the administrator may enter names of data elements. Additionally, the metric construction and storage module 204 may have access to lists, suitably retrieved from the resource library 128. An administrator may select a name from a list, or for more complex data elements may retrieve a sequence of names presented in a succession of lists. For example, an administrator may wish to build a metric record providing information about a high level metric. The high level metric is influenced by a set of lower level metrics. The resource library 128 may suitably include a set of searchable data designations. The resource library 128 may include linkages between higher and lower level data designations that can be imported into a metric record. Alternatively, the administrator may search for a higher level data designation, may search for the lower level data designations and may specify linkages between the higher level designation and the lower level designations. Thus, the administrator may search for and import stored data designations and is not required to remember or produce data designations.

Additional information included in a metric record includes display format information, name and contact information for the party who can explain the performance of the metric, for example a person responsible for monitoring the transactions or occurrences influencing the metric, and other desired information, for example notes explaining how the metric is calculated or explaining the behavior of the metric. The notes and other desired information may be implemented so that the information is not displayed at the initial presentation of the metric record, but can be selected for display by a reviewer, for example by activating an “information” icon.

The administrator can navigate forward and backward through a succession of hypertext pages or other displays in order to fill in information defining the metric. Once the administrator has finished filling in the information, he or she may indicate that construction or modification of the metric is complete, suitably by activating a “submit” button or other icon on a display page. Once the metric has been submitted, the information is used to create or update a metric record in the metric database 128.

As noted above, the administrator module 118 allows the administrator to establish or modify goals and targets for metrics. If the administrator makes a selection to set goals and targets, the administrator interface module 202 invokes the goal and status setup module 206. The goal and status setup module 206 presents a set of displays, such as hypertext pages, allowing the administrator to designate a metric and to set parameters or goals, such as growth, customer satisfaction level, delinquency rates and the like, against which the metric is to be compared. The goal and status setup module 206 may suitably be used to set goals against which groups of metrics are to be compared simultaneously, or may be used to establish desirable or undesirable relationships between metrics. The goal and status setup module may further be used to set a status indicator for each metric depending on how the value of the metric compares to the goals or standards established for the metric. The status indicator may suitably be a displayed as a verbal categorization, such as excellent, satisfactory, marginal or unsatisfactory, a color coded status icon, such as a green, yellow or red circle or any other element calculated to give a quick insight into the status of the metric. In addition, the status of the metric is preferably shown as a hypertext link when the metric is presented. Activation of the hypertext link suitably brings up additional details relating to the status of the metric, for example a more detailed display of the goals and standards for the metric and a notification as to whether the metric meets or falls short of the goals. The display of the status indicator thereby allows a reviewer to gain a quick impression of the status of the metric and to easily elicit additional details if desired.

The presentation format module 208 allows an administrator to define various aspects of the presentation of metrics. The presentation is suitably accomplished by displaying various parameters of the metric in the form of a chart, with the chart suitably having the form of a graph, table or other suitable layout. The presentation format module 208 allows the administrator to establish a default format for the presentation of the metric. Suitably, as will be further discussed below, a reviewer may change the way the metric is presented using features of the presentation module 122. The presentation format module 208 suitably allows the administrator to set visual characteristics of a chart, such as fonts, colors, column widths, scales of graphs and the like.

If desired, an administrator has designed a metric record may suitably store the layout of the metric record in the resource library 128 for use as a template by other administrators. A stored layout may suitably be used by other administrators who wish to design metric records having similar properties and formatting.

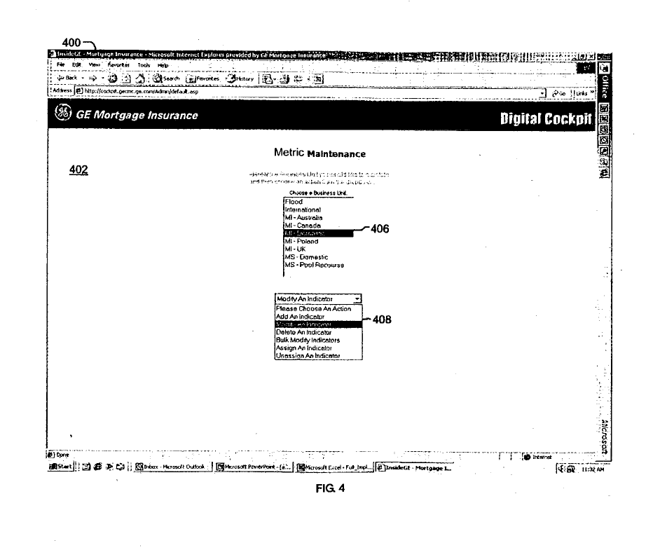

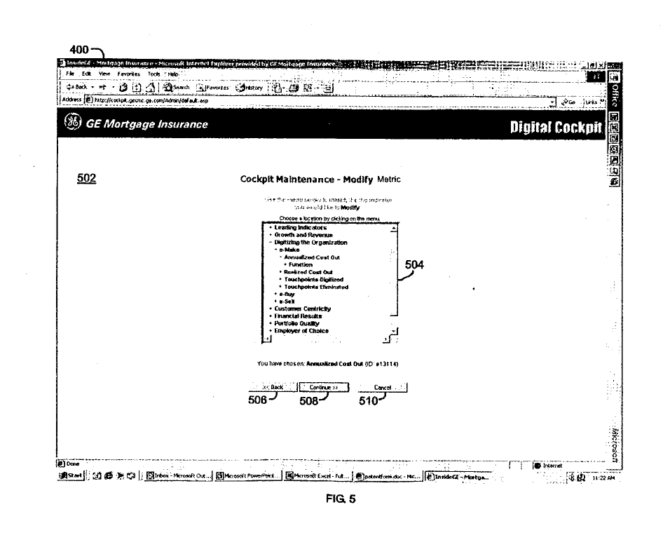

FIG. 3 illustrates a set of displays generated by the administrator module 118 and used as an initial interface to the administrator module. FIG. 3 and subsequent FIGS. 4-16 illustrate exemplary displays generated by a system for evaluating the provision and management of mortgage insurance, but suitably modified displays may easily be generated for any of a wide variety of enterprises. FIG. 3 shows a hypertext browser window 300 displaying an initial administrator menu 304. The menu 304 includes selections 306A-306F for managing metrics, goals and presentation choices. The selections 306A-306F are presented in the form of hypertext links, so that activating a selection passes appropriate parameters to and invokes an appropriate module. The “Metric Maintenance” selection 306A invokes the module 204, the “Chart View Maintenance” selection 306B invokes the module 208, and the “Target Info Maintenance” selection 306C and the “Status Tracking Maintenance (PCMS)” selection 306D invoke a goal and status setup module the module 206.

The “Batch Load Template” selection 306E suitably retrieves a user interface, such as a hypertext form, allowing a user to submit a metric or set of metrics that have been prepared offline. The user interface preferably includes one or more fields for entry of a path and filename for a file containing metric information to be added to the metric database 126. If a user skilled in the use of tools such as spreadsheets or databases wishes to create a relatively large number of metric records at one time, he or she may find it more convenient to construct metric records using such tools, without using the more simplified user interfaces provided by a metric construction and storage module such as the module 204 and a goal and status setup module such as the module 206. The “Batch Load Instructions” selection 306F retrieves instructions for batch loading of metrics, for example an explanation of how to submit path and filename information and notes on how to construct sets of metric information using tools such as spreadsheets and databases.

FIG. 4 illustrates a hypertext browser 400 displaying an introductory hypertext page 402, that may suitably be generated as a user interface for metric construction using the module 204. The page 402 may suitably be retrieved by activation of the “Metric Maintenance” selection 306A. The exemplary page 402 and following pages illustrate an interface for construction of metrics relating to an enterprise carrying out mortgage insurance underwriting and administration. The page 402 includes a business unit selection list 406 and an action selection dropdown list 408. Upon a user selection from the list 406 of a business unit for which metrics are to be constructed and selection of an action from the list 408, the metric construction and storage module 204 retrieves the next page in a set, in order to allow selections and entries for construction of a metric.

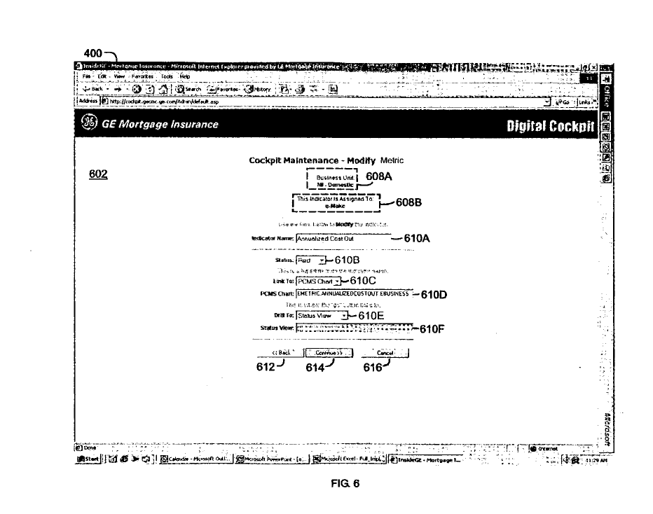

FIG. 5 illustrates the hypertext browser 400, displaying a page 502 used in construction of a metric and invoked following a selection to modify a metric using the page 402. The page 502 includes a metric selection list 504, and navigation buttons 506, 508 and 510. The buttons 506 and 508 allow navigation backward to the next page in the set or return to the previous page in the set, respectively. The button 510 allows abandonment of the creation of the metric and a return to the page 302.

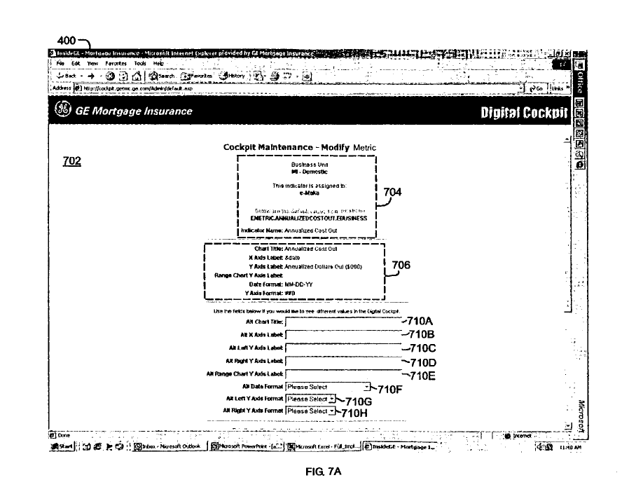

FIG. 6 illustrates the hypertext browser 400, displaying a page 602 following selection of the list entry “e-make” from the list 504 of FIG. 5 and navigation forward using the button 508 of FIG. 5. The page 602 includes description elements 608A and 608B, identifying the selections chosen using the pages 402 and 502. The page 602 also includes fields and selectors 610A-610F for entering metric information. Because the metric is a previously existing metric and is being modified, the fields and selectors 610A-610F include previously entered information, which may be modified by the administrator as desired. The field 610A shows the metric name. The selector 610B shows the metric status, which has already been computed by the data management module 120, by comparing the metric value against established goals. The selector 610C and the field 610D show the source of data for the metric, following a standardized format used for the operations database 104. The selector 610E establishes a link to the grouping of metrics of which the metric being modified is a member, and the field 610F allows the entry of additional information. The buttons 612-616 allow navigation to a subsequent or previous page or abandonment of the operation.

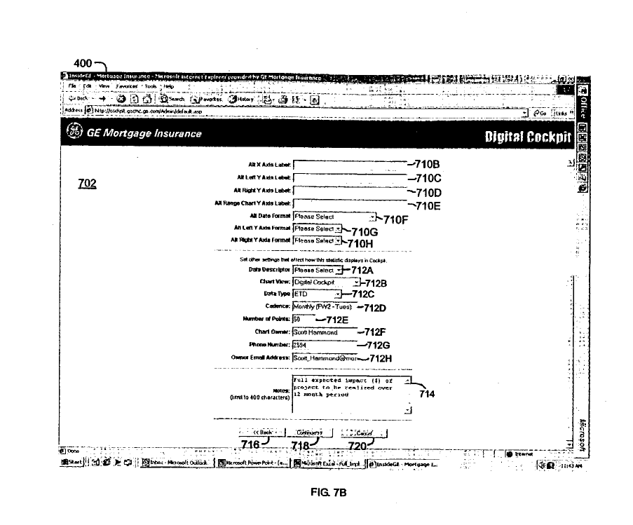

FIG. 7A illustrates the hypertext browser 400 displaying a hypertext page 702, displayed as a result of navigating forward from the page 602. The page 702 includes information elements 704 and 706. The information element 704 includes previously entered details, and the information element 706 includes present status information, subject to modification. The fields and selectors 710A-710H allow user entries allowing the user to design a graphical format for the metric under construction. A change in one of the fields and selectors 710A-710H results in a modification of the data displayed in the information element 706.

FIG. 7B illustrates the hypertext browser 400, displaying the hypertext page 702 after it has been scrolled down. The fields and selectors 710A-710H can be seen, as well as additional fields 712A-712H. The selectors 712A-712C include dropdown lists for selection of standardized data descriptors, view formats and data types, respectively. The administrator uses these fields to specify default formats to be used to present data. Preferably, a user reviewing the data will initially be presented with these default formats, but will be given the opportunity to customize the way the data is viewed.

The fields 712D and 712E illustrate the time scale, in this case, a monthly time scale, over which the metric is to be displayed and the resolution of the metric display, respectively, and the fields 712F-712H include name and contact information for the party responsible for the metric. The page 702 also includes a note field 714, allowing the creator of the metric to enter desired supplementary information, for example a metric description and a formula used to compute the metric value. The page 702 also includes navigation buttons 716-720, allowing navigation to the following or previous page, or abandonment of creation of the metric.

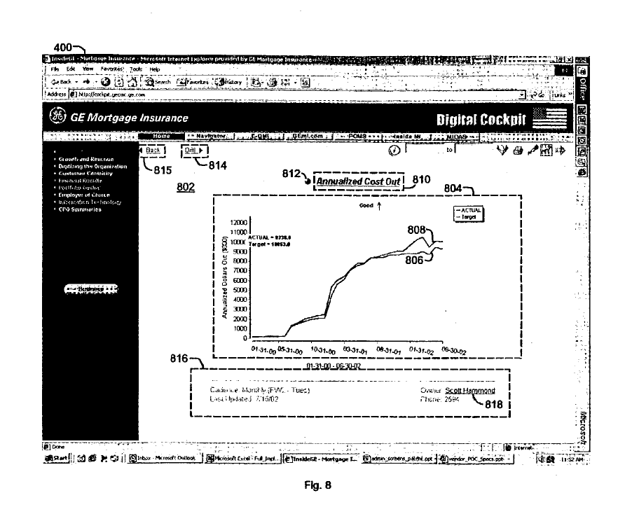

FIG. 8 illustrates the hypertext browser 400, displaying a hypertext page 802, displayed as a result of navigating forward from the page 702. The page 802 illustrates a preview showing the presentation of the metric as designed using the pages 402-702. The display of the metric includes a graph 804, showing curves 806 and 808 representing actual and target values, as well as a hypertext link 810 representing the metric name, which may be activated to show the metric source, as well as a status indicator icon 812. Activation of the status indicator 812 displays details about the goals for the metric, as well as how close the metric is to meeting the goals. The page 802 also includes a “Drill” link 814, activation of which retrieves names of and links to related metrics, for example metrics having a position in the hierarchy below that of the displayed metric. The retrieval of links to related metrics will be discussed in further detail below in connection with further discussion of the presentation module 122 and displays generated by the use of the presentation module 122. The display 802 also includes a “Back” hypertext link 815, to allow navigation to the page 702, and also includes an information block 816 comprising time scale information, the last date of the last update, the name of the party responsible for the metric and the telephone number of the responsible party. The name of the party responsible for the metric is given in the form of a hypertext link 818, activation of which opens an email addressed to the responsible party.

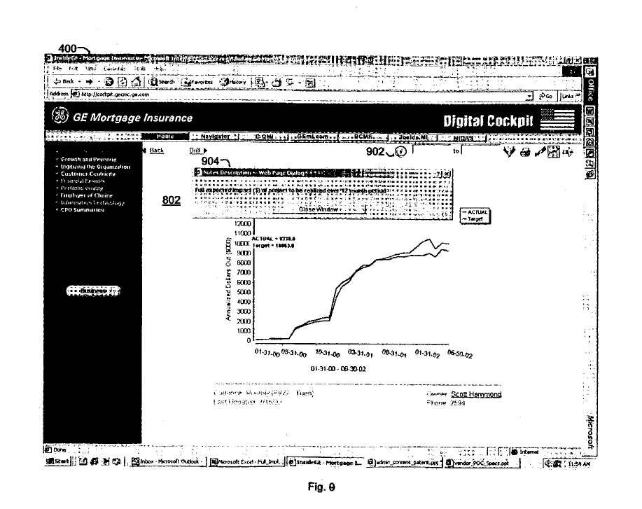

FIG. 9 illustrates the hypertext browser 400, displaying the page 802, after an “information” icon 902 has been activated to display an information dialog box 904, showing the information entered in the note field 714.

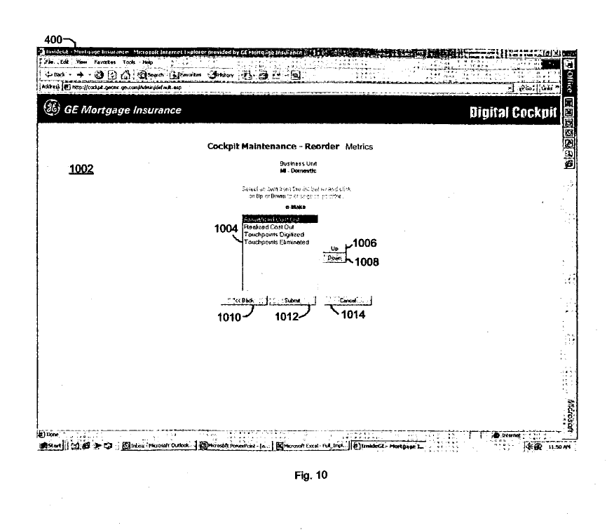

FIG. 10 illustrates the hypertext browser 400, displaying a final page 1002 for assembly and submission of a metric record. The page shows a reorder list 1004 and “Up” and “Down” list navigation buttons 1006 and 1008, respectively. The buttons 1006 and 1008 allow the administrator to move a selected element in the list 1004, so as to reorder the presentation of the elements. The page 1002 also includes a “Back” button 1010, to return to the page 802, a “Submit” button 1012, to allow submission of the metric record into the database 126, and a “Cancel” button 1014, to allow abandonment of the modification of the metric record.

Once a metric record is created, an administrator may set parameters against which to compare the value of the metric or metrics in the metric record, in order to provide an easy way for a reviewer to monitor the metric information. As will be discussed further below, metric information may suitably be presented in charts or lists, and setting a status for a metric allows a reviewer to restrict a chart to metrics having a particular status, such as an unacceptable or marginal status, or to accompany metrics with status icons so that it is easy to look through the list for icons indicating the status of a metric.

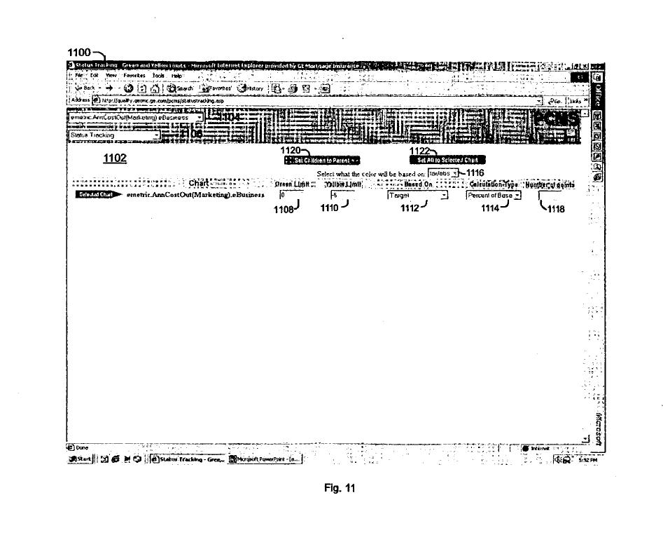

FIG. 11 illustrates a hypertext browser 1100, illustrating a hypertext page 1102, presented upon selection by an administrator of the selection 306D of the page 302. The page 1102 allows the entry of parameters used to establish status boundaries for a metric, and is shown here as being used to set boundaries for the metric developed using the displays illustrated in FIGS. 4-10. The page 1102 includes a selection list 1104, allowing selection of the metric for which standards are to be set, as well as an operation list 1106, allowing the user to choose a particular operation. The status designation is used to set color coding for status icons associated the metric in a display. Thus, the page 1102 includes limit fields 1108 and 1110 to allow entry of the limits for a “green” status or a “yellow” status, respectively, a selector list 1112 to indicate the base parameter on which the status determination is to be based and a “Calculation Type” list 1114 to select how the limit fields 1108 and 1110 are to be treated. In the presently illustrated case, the fields are represented as a percentage of the base parameter, that is, status is determined by comparing the percentage of deviation of the metric from the base parameter against the limits.

The page 1102 also includes a selector list 1116, indicating the basis for the color coding to be used, a field 1118 to allow the administrator to enter the resolution of the computation, and group action buttons 1120 and 1122. The button 1120 allows an immediate copying of the status parameters of the selected metric to all metrics lower in the hierarchy to which the selected metric belongs, and the button 1122 allows an immediate copying of the status parameters of the selected metric to all metrics in the same group to which the selected metric belongs.

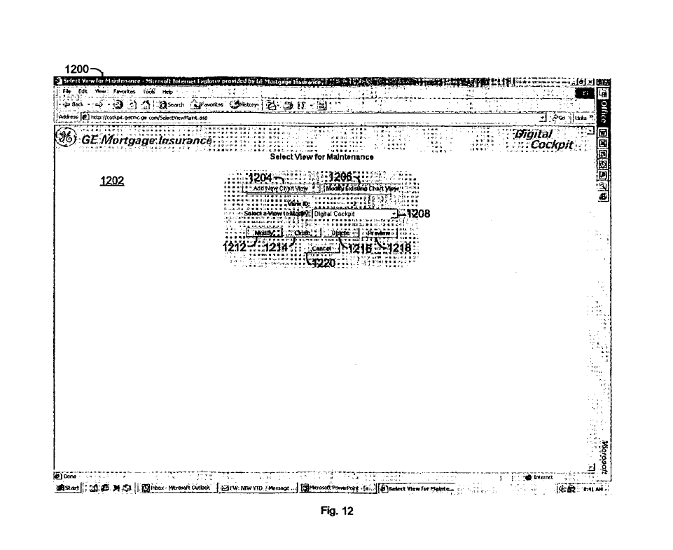

The presentation format module 208 allows the administrator to control the visual format in which metrics are presented. FIGS. 12-16 illustrate a set of hypertext pages allowing an administrator to set general visual formatting rules to be followed in the presentation of metrics.

FIG. 12 illustrates a hypertext browser 1200, displaying a hypertext page 1202 reached upon activation of the selection 306B of FIG. 3. The page 1202 includes selector buttons 1204 and 1206, allowing the choice of adding or modifying a view, respectively, a selector list 1208 allowing specification of a view to be modified and various activation buttons, 1212-1216, allowing modification, copying, and deletion of formatting, respectively, and an activation, or preview, button 1218, allowing the administrator to view a sample chart showing the effect of the choices that have been made. The page 1202 also includes a “Cancel” button 1220, allowing abandonment of the formatting addition or changes.

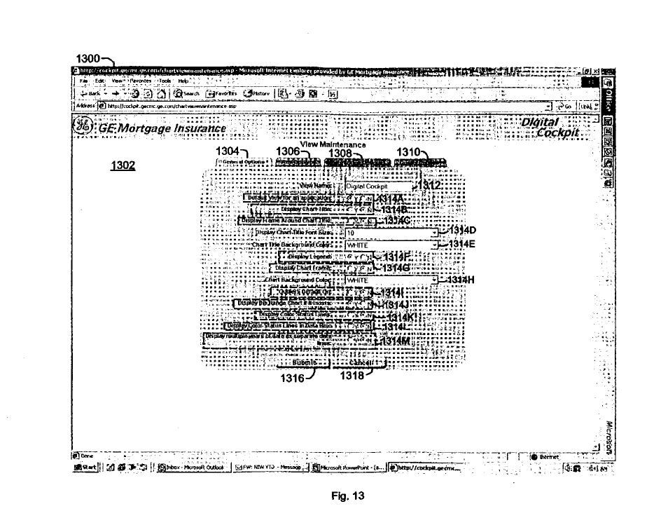

FIG. 13 illustrates a hypertext browser 1300, displaying a hypertext page 1302, reached upon selection of the button 1206 of FIG. 12. The page 1302 includes options tabs 1304-1310, of which the “General Options” tab 1304 is presently selected. The page 1302 shows a view name field 1312, shown here as filled in with the previously chosen name, as well as selector fields 1314A-1314M. The page 1302 also includes “Submit” and “Cancel” buttons 1316 and 1318, respectively.

FIG. 14 illustrates the hypertext browser 1300, displaying the hypertext page 1302 with the “Axis Options” tab 1306 selected. The page 1302 here displays selector fields 1402A-1402G, allowing a user to set up parameters and characteristics used to present a metric in a graphical display. The page 1402 also includes “Submit” and “Cancel” buttons 1404 and 1406, respectively.

FIG. 15 illustrates the hypertext browser 1300, displaying the hypertext page 1302 with the “Data Series Options” tab 1308 selected. The “Data Series” display is a display of a set of related metrics in table form, suitably with a status icon accompanying each metric. The page 1302 here displays selector fields 1502A-1502L with activation buttons 1 504, 1506 and 1508 for entering the choices selected, using the 15021, 1502J and 1502K selectors, respectively. The page 1302 also displays a selection summary chart 1510, showing the pending selections made using the selector fields 1502A-1502L, as well as “Submit” and “Cancel” buttons 1512 and 1514.

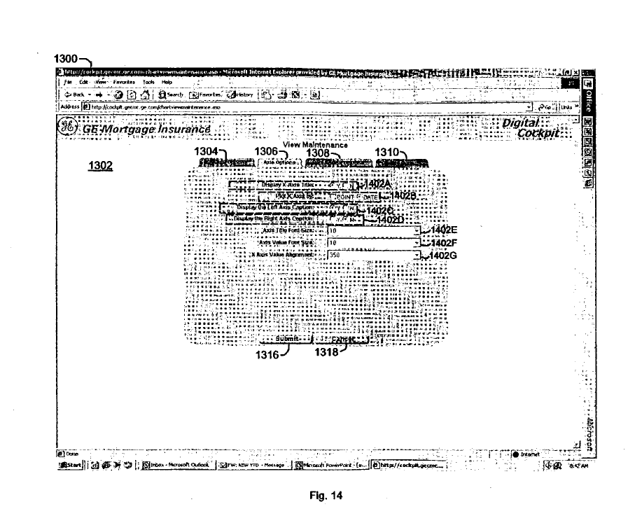

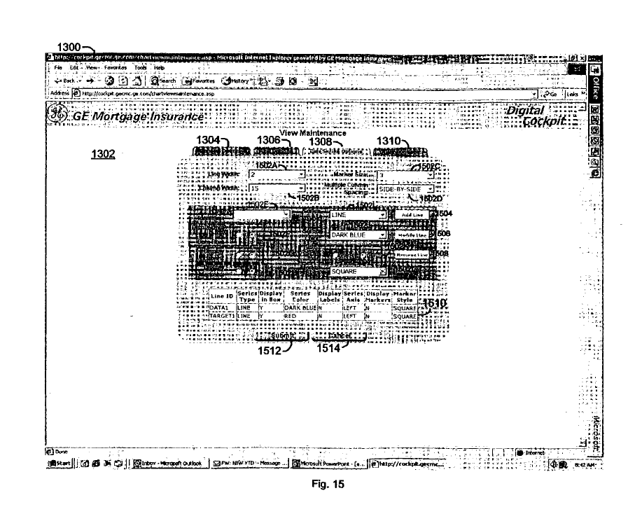

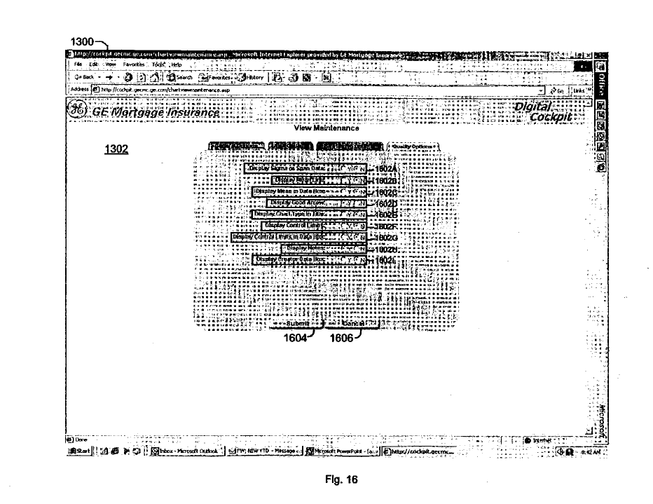

FIG. 16 illustrates the hypertext browser 1300, displaying the hypertext page 1302 with the “Quality Options” tab 1308 selected. The page 1302 here includes a set of feature selectors 1602A-16021, allowing an administrator to choose whether or not various statistical parameters related to metrics and comparisons of metrics to targets and goals are to be displayed. The page 1302 also includes “Submit” and “Cancel” buttons 1604 and 1606.

Once a metric has been created and stored, it is available for examination by the data analysis module. The data analysis module 120 retrieves the metric from the metric database 126, examines the parameters of the metric and examines the operations database 104 to identify data elements that contribute to the value or values of the metric. The data analysis module computes the value or values for the metric and updates the metric record with the computed value or values.

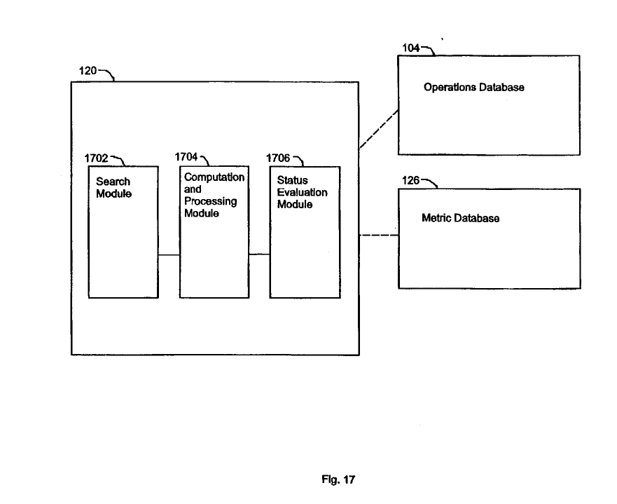

FIG. 17 illustrates additional details of the data analysis module 120 of FIG. 1. The data analysis module 120 suitably exchanges data with the metric database 126 and the operations database 104. The data management module 120 suitably comprises a search module 1702, a data computation module 1704 and a status evaluation module 1706. The search module 1702 searches the metric database 126 for metric records and, for each metric record, searches the operations database 104 for information to be used to compute the value of the metric. Such information suitably comprises data elements identified, either individually or as members of a group or class, by fields in the metric record indicating the source of data for the metric. Each record in the metric database 126 and the operations database 104 is preferably dated so that the search module 1702 identifies only data elements appearing in a record that has been created or updated since the last time the record was examined.

As the search module 1702 identifies data elements, the data computation module 1704 uses the data elements to perform computations to update the value of the metrics. Such computations may suitably be computation of sums, such as addition of sales to gross revenues, computation of averages, for example recomputation of average delinquency rates to incorporate newly received data or any other computation indicated by the parameters for the metric whose value is to be computed. Computation may also suitably include computation of trends over time, such as sales growth over a month or a quarter. As values are computed for each metric, the metric record is updated in the metric database 126.

As the data computation module 1704 computes values for the metrics, the status evaluation module 1706 compares the value of the metric against the goals and standards that have previously been established. The status evaluation module 1706 sets status metrics based on the comparison and updates the metric record to include the latest status settings.

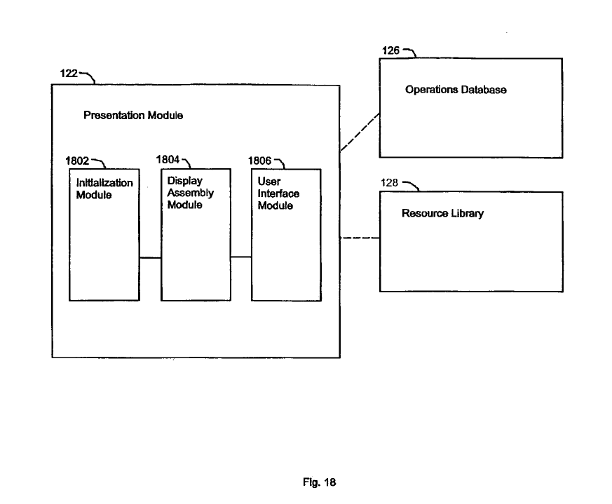

FIG. 18 illustrates the presentation module 122 according to an aspect of the present invention. The presentation module 122 interacts with the metric database 126 and the resource library 128. The presentation module 122 preferably includes an initialization module 1802, a display assembly module 1804 and a user interface module 1806. Upon initial invocation of the presentation module 122, suitably by a user's pointing a hypertext browser to a hypertext page invoking the presentation module 122, the initialization module 1802 examines the identification of the user from which the invocation was received, identifies the information of interest to the user and passes parameters describing this identification to the display assembly module 1804. The display assembly module 1804 retrieves appropriate templates from the resource library and appropriate metric records from the metric database 126 to assemble an initial display appropriate for the user. The initial display may suitably be in the form of a hypertext page including a table of high level metrics for which the user has reviewing responsibility. For a manager, the items might be revenue, costs, profitability and similar items. For a salesperson, the items might be customer contacts, percentage of customer contacts resulting in sales, average dollar sales per customer contact and the like.

Once the appropriate display has been assembled, the display assembly module 1804 passes it to the user interface module 1806 for presentation to the customer. Each display preferably includes commands that may be activated by the user and processed by the user interface module 1806 to provide instructions to the display assembly module for construction of a new display. Thus, upon selection of an item from the initial menu, the user interface module 1806 prepares a command represented by the selection and directs the display assembly module 1804 to prepare a subsequent display responsive to the selection. The display is then presented using the user interface module 1806. Each display preferably includes desired information as well as command elements, so that a user can navigate through displays as desired, reviewing needed information.

As noted above, metric records typically include identifications of groupings and hierarchies to which the metrics belong. Thus, many of the displays prepared by the display assembly module 1804 will preferably include links to groupings, so that a user viewing a metric may easily retrieve a list of related metrics. For example, the “Drill” command discussed above in connection with FIG. 8 retrieves related metrics. Depending on the design of the metric record, activation of the “Drill” command may suitably retrieve metrics subordinate to the metric being viewed, or may retrieve metrics related in some other way to the metric being viewed. For example, a metric record designed to yield information about revenue for a class of products may implement the “Drill” command so as to retrieve subordinate metrics yielding information about revenue for members of the class of products. Alternatively, the “Drill” command may be implemented so as to retrieve related metrics yielding information about revenue from other classes of products, to allow comparisons with the class of products under review.

Additionally, the name of each metric in the list may suitably be a hyperlink, to allow the user an easy way to retrieve a display of that metric. Each display also preferably includes numerous other hyperlinks and input fields to allow the user to retrieve information or to change the format in which information is displayed. For example, status icons may appear as hyperlinks, which provide additional status information when activated, a display may have fields allowing a user to change the time period over which metric averages or trends are computed and the like.

The display assembly module 1804 is suitably operative to make necessary computations if the desired display includes a compilation of metrics, a sum or average of metrics or use of another value not achievable by the simple retrieval of existing metrics. The display assembly module 1804 also, depending on predetermined choices and user selections made during operation, selects a desired format for presentation of the information. Exemplary formats include line graphs, histograms, tables, pie charts and the like. The display assembly module 1804 prepares appropriate displays for presentation employing the user interface 1806.

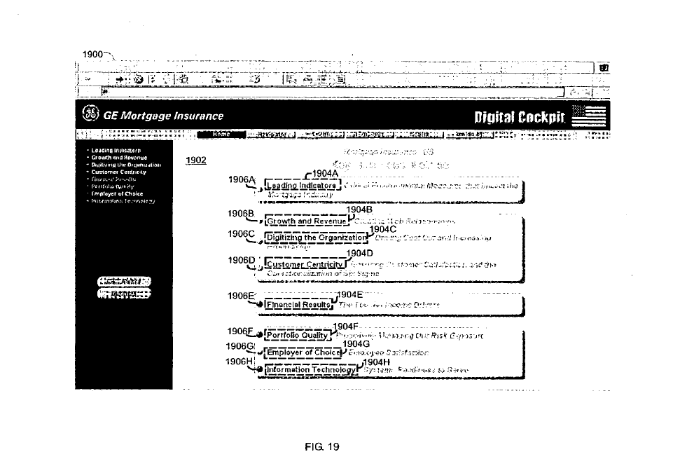

FIGS. 19-23 are a series of displays generated using the presentation module 122. The exemplary displays presented here are the result of various representative selections that might be made by a user in reviewing desired information.

FIG. 19 illustrates a hypertext browser 1900 displaying an introductory hypertext page 1902. The page 1902 provides a list of menu selections 1904A-1904H for various top level metrics for a mortgage insurance enterprise. It will be recognized that the choice of a mortgage insurance enterprise is only made so as to give a concrete example and that the pages illustrated in FIGS. 19-23 could suitably be adapted, and other similar pages could suitably be designed, to provide information about enterprises of almost any kind. Each of the selections 1904A-1904H is in the form of a hypertext link providing the name of the metric, and accompanied by explanatory text. Each of the selections 1904A-1904H is accompanied by one of the status indicators 1906A-1906H, respectively. Each of the status indicators 1906A-1906H is in the form of a hypertext link, each of which is in the form of a color coded circle imparting immediate information about the overall status of the performance category. The performance of a category is determined by a set of metrics influencing the performance of the category. Each metric is assigned a weight showing its influence on the category. Activation of one of the status indicators 1906A-1906H retrieves further information about the goals and standards used to evaluate the associated metric.

Activating one of the menu selections 1904A-1904H retrieves a subsequent page providing additional information and selections relating to the selection. Each of the metrics represented by one of the selections 1904A-1904H is at the top of a hierarchy, with a number of other metrics contributing to it, and activating a selection retrieves a page comprising information describing lower level metrics, including a number of hyperlinks that can be activated to retrieve still more detailed information and additional choices available for one or more of the lower level metrics.

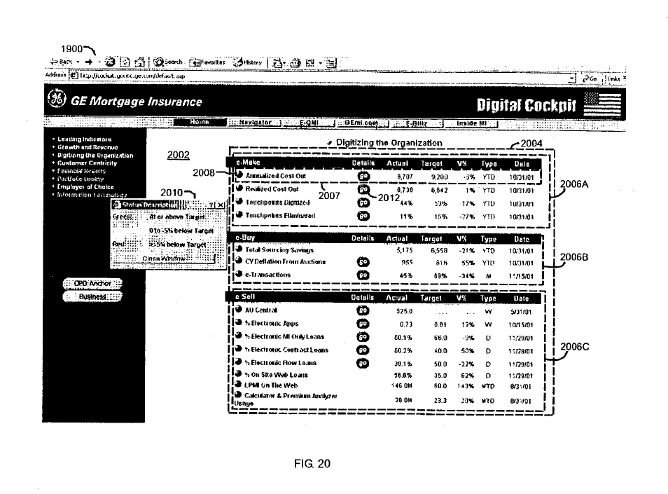

FIG. 20 illustrates the hypertext browser 1900, displaying a hypertext page 2002, reached upon activation of the “Digitizing the Organization” selector 1904C of FIG. 19. The page 2002 includes a table 2004 of lower level metric descriptions, presented in three related groupings 2006A, 2006B and 2006C. A representative metric description is the description 2007. Each metric description includes a status indicator such as the status indicator 2008, shown here as having been activated to display a legend box 2010. Each metric description also includes a “Go” button, such as the button 2012, which can be activated to retrieve additional details about the associated metric.

FIG. 21 illustrates the hypertext browser 1900, displaying a hypertext page 2102, reached upon activating the “Go” button associated with the metric description 2007 of FIG. 20. The page 2102 comprises a graph 2104, showing curves 2106 and 2108, plotting actual and target values, respectively, over time. The page 2102 also comprises a metric name element 2110, implemented as a hypertext link. Activation of the hypertext link returns to the previous page. The name element 2110 is accompanied by a status indicator 2112.

The page 2102 further comprises an “information” icon 2114, shown here as having been activated to retrieve a note box 2116. The page 2102 additionally comprises date fields 2118 and 2120, to allow a reviewer to graph results over a selected time period. The page 2102 comprises an information section 2122, including details about the creation, maintenance and ownership of the associated metric record. Finally, the page 2102 comprises a “Drill” command 2124, implemented as a hypertext link whose activation retrieves metric descriptions for a group of lower level metrics.

FIG. 22 illustrates the hypertext browser 1900, displaying a hypertext page 2202, reached after activation of the “Drill” command 2124 of FIG. 21. The page 2202 comprises a metric description table 2204, having features similar to those of the table 2004 of FIG. 20 and comprising a set of descriptions of lower level metrics including the representative description 2205, as well as a header 2206, showing the name and status of the top level metric to which the metrics listed in the table 2204 are subordinate.

FIG. 23 illustrates the hypertext browser 1900, displaying a hypertext page 2302, reached after selection of the metric description 2205 of FIG. 22. The page 2302 comprises a graph 2304, having features similar to those of the graph 2104 of FIG. 21 and plotting values of the selected metric over time.

Each high level metric may represent a compilation or average of lower level metrics that influence the value of the high level metric. The data presented by each display may also be related to additional data that influences or is relevant to the information presented. In addition, a user may wish to select only particular data for viewing or may wish to view properties of data items that are presented. A display assembled by the display assembly module 1804 may therefore include a set of filtering or selection tools to allow user selection of underlying data. For example, an enterprise may have a plurality of business units and may wish to allow display of financial results for each business unit. Each metric record may therefore include a designation of the business unit producing the record, allowing a display to be easily assembled compiling results for a particular business unit. Further, each metric in a set of financial results may be influenced by transactions conducted with each of a plurality of customers. It may therefore be desirable to associate each metric record with a particular customer, to allow identification of results for that customer. Displays presented by the display assembly module 1804 may suitably include filtering tools so that a user viewing a set of high level results may designate a particular customer, for example, and view a similar set of results, with the displayed results being restricted to those reflecting transactions with a specified customer. Other filtering tools may allow display only of metrics meeting or failing to meet a goal, metrics having a positive or negative trend or the like.

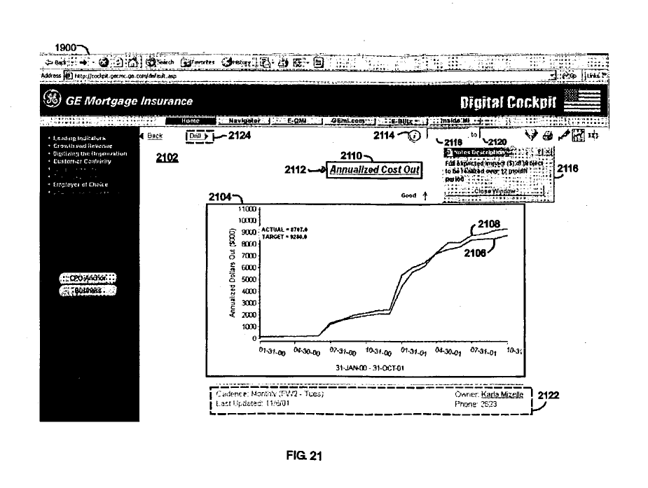

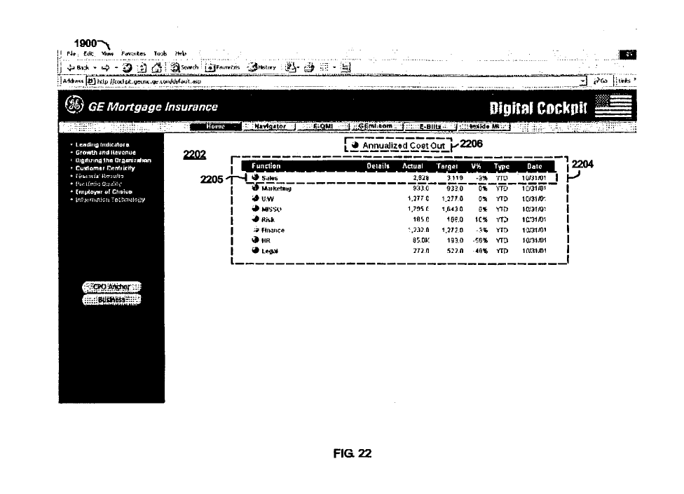

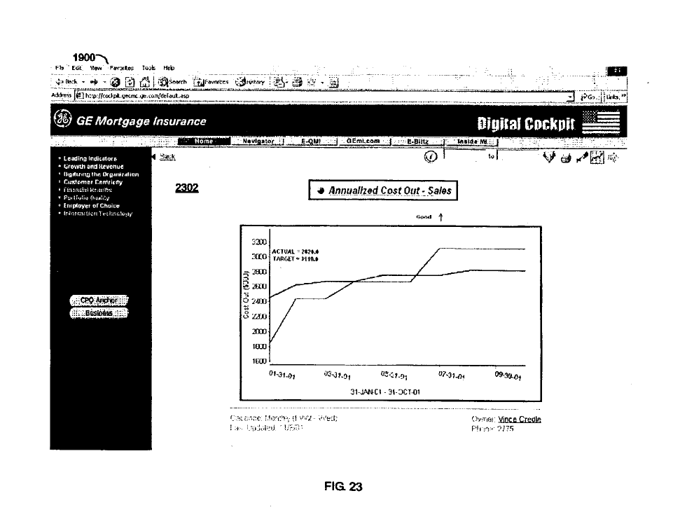

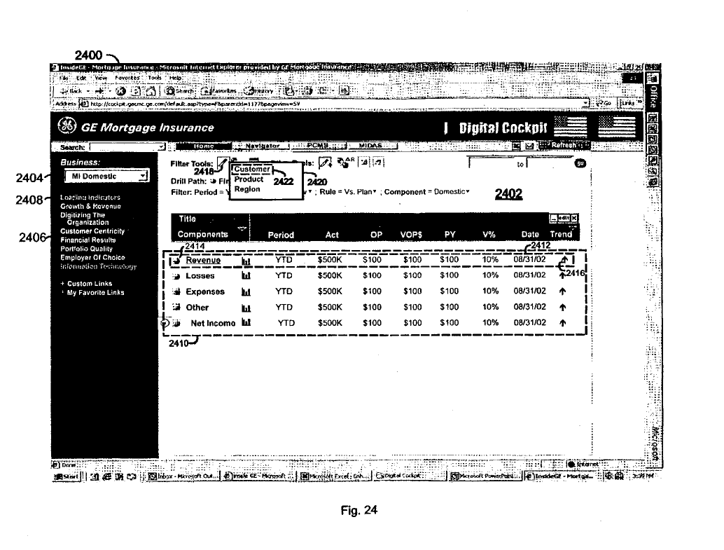

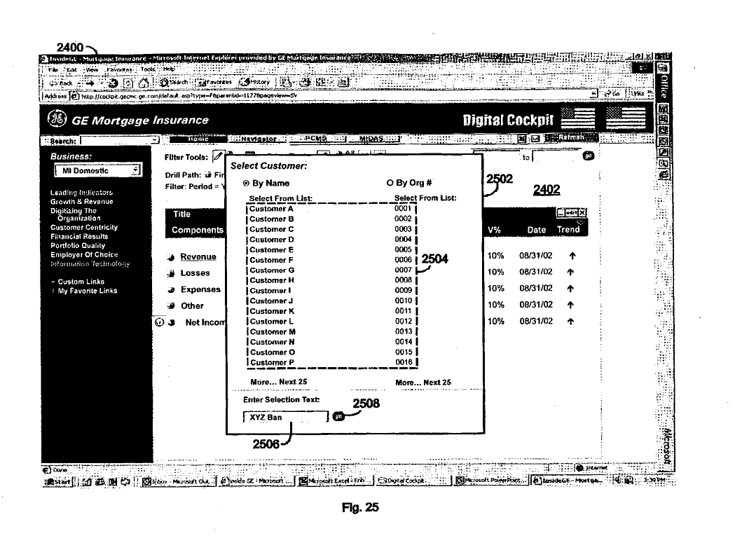

FIGS. 24 and 25 are displays generated using the presentation module 122. The displays 24 and 25 include filtering tools to allow the reviewer to specify metrics to be displayed.

FIG. 24 illustrates a hypertext browser 2400 displaying a hypertext page 2402. The page 2402 includes a business unit selector 2404, allowing a reviewer to specify a business unit for which metric information is to be presented. Selection of a business unit limits the information presented to the selected business unit. The page 2402 also includes a metric category list 2406, allowing a reviewer to specify the information to be presented. The entries in the category list are presented as hypertext links. The “Leading Indicators” entry 2408 is selected, causing the display of leading financial indicators for the “Ml Domestic”, that is, domestic mortgage insurance, business unit selected using the selector 2404.

A table 2410 is presented as a result of the selections, showing entries providing top level financial information. A representative entry is the entry 2412. The entry 2412 includes a status indicator 2414, whose color shows the performance of the metric relative to the established goals, as well as a trend arrow 2416. The direction of the trend arrow 2416 shows the performance of the metric over time, and the color of the trend arrow 2416 shows the relationship between the metric performance over time and the performance goals.

The page 2402 also includes a filtering tool 2418, allowing the reviewer to refine the information displayed. Use of the filtering tool 2418 causes display of the metrics presented in the table 2410, but having values, status indicators and trend arrows relating to the categories or classes of information specified using the filtering tool 2418. It can be seen that the filtering tool 2418 has been activated to display a selection table 2420. The selection table 2420 allows the reviewer to choose the type of filtering to be performed. In the present case, the “Customer” entry 2422 has been selected, indicating that a further selection is to be made in order to restrict the presentation of information to that relating to a selected customer.

FIG. 25 illustrates the browser 2400, displaying the page 2402 after the “Customer” entry 2422 has been selected. A customer selection box 2502 has been displayed, allowing the reviewer to select the customer for which information is to be displayed from a customer list 2504. Alternatively, the reviewer can enter the name of the customer in the field 2506. In the present case, the customer XYZ Bank has been selected. The selection is submitted using the “GO” button 2508, causing the recomputation of the metrics presented in the table 2410 to be recomputed to reflect those relating to transactions with the selected customer, in this case XYZ Bank.

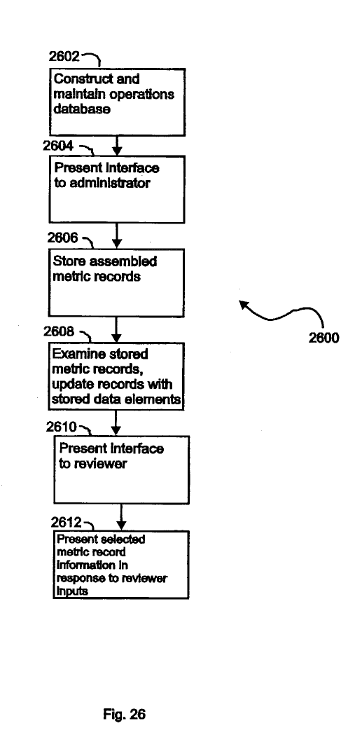

FIG. 26 illustrates the steps of a process 2600 of data management and evaluation according to an aspect of the present invention. At step 2602, an operations database is constructed and maintained to store data generated in the carrying out of an enterprise employing the database. The data stored preferably provides insight into the activities of the enterprise. At step 2604, upon submission of identification information by an administrator, an interface is presented to an administrator, allowing the administrator to assemble metric records identifying data bearing on a desired aspect of the enterprise. The interface is preferably tailored to the particular administrator invoking the interface and is directed toward receiving information in categories for which the identified administrator is responsible, but preferably provides means for the administrator to direct the interface to accept data in any category that the user is authorized to submit.

Each metric record preferably provides a format for retrieval and processing of data elements that provide insight into one or more aspects of the enterprise, and presentation of the data contained in the data elements. The metric record preferably includes identification of the source of the data elements to make up the metric record, groupings and hierarchies to which the metric record belongs, values against which the data contained in the metric record is to be compared, and formatting choices for presentation of the data to a reviewer. The interface preferably comprises a plurality of templates allowing selections by the administrator, as well as entry of data in fields, but may also include an interface to allow an administrator to load one or more files comprising existing data assembled using data management tools. The interface is preferably designed so that the administrator can navigate freely through the interface as desired, entering data in any convenient order.

At step 2606, upon entry by the administrator of the desired data and a direction to submit the metric record, the metric record is stored in a metric database. Steps 2604 and 2606 may be performed at any time, whenever an administrator wishes to prepare and submit records.

At step 2608, at suitable intervals, the records in the metric database are examined. For each metric record, the data identified in the metric record is located in the operations database and processed according to identification and instructions in the metric record. The values of the metrics identified by the metric record are computed and the metric record is updated with the values. Updating of the metric record suitably includes comparison of the value of the metric against predetermined goals and standards and setting of status flags based on the results of the comparison.

At step 2610, upon a request by a reviewer, an interface is presented allowing the reviewer to direct display of the information contained in the metric records. The interface suitably allows the user to select individual records, or classes or categories of records for review and to navigate freely between records as desired.

At step 2612, the information contained in the metric records is displayed as directed by the reviewer. The initial presentation of the information is suitably formatted according to instructions contained in the metric records, but may be altered according to inputs from the reviewer. The interface preferably allows the reviewer to navigate freely between metric records, and the display of each metric record preferably provides for easy retrieval of metric records within the same hierarchy or grouping.

While the present invention is disclosed in the context of aspects of a presently preferred embodiment, it will be recognized that a wide variety of implementations may be employed by persons of ordinary skill in the art consistent with the above discussion and the claims which follow below.

1. A system for generating and presenting data elements providing insight into the operations of an enterprise, comprising:
a plurality of servers and workstations for carrying out activities in the operation of the enterprise;
an operations server for storing data elements generated during the activities of the enterprise in an operations database;
an analysis server for collecting, processing and presenting the data elements so as to provide insights into the performance of the enterprise;
a data management application hosted on the analysis server, the data management application comprising:
an administrator module for allowing an administrator to enter selections for assembling a metric record including metric information providing insight into the performance of the enterprise, the administrator module being operative to store each metric record in a metric database upon completion;
a data analysis module for examining each metric record in the metric database and searching the operations database, the data analysis module being operative to process data elements identified in the metric database in order to compute values for the metric information included in the metric record and to update each metric record with the computed values; and
a presentation module for searching the metric database in response to inputs from a reviewer requesting information from metric records and presenting the desired information in response to the reviewer inputs.

2. The system of claim 1, wherein the administrator module is operative to receive and store goal and standard information against which the information in the metric records is to be evaluated and to store goal and standard information as part of one or more metric records.

3. The system of claim 2, wherein each metric record includes an identification of the data elements used to compute the values for metric information comprising the metric record and wherein the data analysis module searches the operations database for data elements identified in the metric records.

4. The system of claim 3, wherein one or more metric records includes specifications of operations to be performed to compute values of the metric records and wherein the data analysis module performs the specified operations on the data elements identified as used to compute the values for the metric records.

5. The system of claim 4, wherein each metric record includes group and hierarchy information identifying groups and hierarchies to which the metric record belongs, the group and hierarchy information serving to identify related families of metric records to allow for easy retrieval of related metric record information.

6. The system of claim 5, wherein the group and hierarchy information includes weighting information specifying the influence of metrics on other metrics in the same group or hierarchy.

7. The system of claim 6, wherein each metric record includes format information specifying an initial presentation of the metric record information by the presentation module.

8. The system of claim 7, wherein each of the administrator module and the presentation module presents a user interface in the form of a collection of hypertext pages.

9. The system of claim 8, wherein the presentation module allows a reviewer to customize the presentation of the metric record information.

10. The system of claim 9, wherein the presentation module allows the reviewer to specify time periods over which metrics are to be evaluated and computes and presents the performance of the metric over the specified time periods.

11. The system of claim 10, wherein one or more displays presented by the presentation module includes a status indicator associated with a metric, the status indicator providing a visual indication of how the value of the associated metric relates to the goals and standards established for the metric.

12. The system of claim 11, wherein the status indicator is a hyperlink and wherein activation of the hyperlink displays additional information about the status indicator.

13. The system of claim 12, wherein one or more displays presented by the presentation module includes filtering tools allowing a reviewer to select for display only metric information meeting specified criteria.

14. The system of claim 13, wherein the presentation module is operative to present a list of high level metrics implemented as hyperlinks and wherein activation of one of the hyperlinks presents a list of subordinate metrics contributing to the value of the high level metric.

15. A method of management and evaluation of data generated during the conduct of an enterprise, comprising the steps of:
presenting an administrator with an administrator interface allowing definition of metric records to be used to format and present information providing insight into the activities of the enterprise, each metric record identifying data elements generated in carrying out the activities of the enterprise and stored in an operations database;
upon each entry by the administrator of data defining a metric record, storing of the metric record in a metric database;
examining the metric database for metric records and for each metric record, searching the operations database for data elements identified in the metric record, processing the data elements to compute values for the metric records and updating the metric records with the values;
presenting a reviewer interface allowing a reviewer to direct presentation of information contained in selected metric records; and
presenting selected metric records as directed by the reviewer.

16. The method of claim 15, wherein the initial display of information contained in metric records is conducted according to directions contained in the metric records.

17. The method of claim 16, wherein one or more of the metric records includes standards and goals against which the values contained in the metric records are to be compared and presentation of a metric record includes presentation of status indicators showing whether or not the values meet the standards and goals.

18. The method of claim 17, wherein each of the metric records includes group and hierarchy identification identifying groups of related metric records.

19. The method of claim 18, wherein each of the administrator interface and the reviewer interface comprises a collection of hypertext pages including links to commands and sources of related information.

20. The method of claim 19, wherein the presentation of a metric record includes links to related metric records in the same group or hierarchy.
